(19) United States
(12) Patent Application Publication
(10) Pub. No.: US 2026/0281951 A1
(43) Pub. Date: Sep. 17, 2026

(54) CONGESTION CONTROL FOR THE POSITIONING DEDICATED POOL

(71) Applicant: Telefonaktiebolaget LM Ericsson (publ), Stockholm (SE)

(72) Inventors: Saeedeh MOLOUDI, Linköping (SE); Ricardo BLASCO SERRANO, Espoo (FI); Peter HAMMARBERG, Mölndal (SE); Florent MUNIER, Västra Frölunda (SE)

(21) Appl. No.: 19/471,816

(22) PCT Filed: Apr. 4, 2024
(86) PCT No.: PCT/EP2024/059204

§ 371 Date: Oct. 2, 2025

Related U.S. Application Data
(60) Provisional application No. 63/494,943, filed on Apr. 7, 2023.

(51) Int. Cl. H04W 64/00; H04B 17/318

(52) U.S. Cl. CPC H04W 64/00; H04B 17/328

(57) ABSTRACT

A method, system and apparatus are disclosed. In an example embodiment, a user equipment (UE) configured to communicate with another device is provided. The UE is configured to perform at least one measurement regarding sidelink positioning reference signaling (SL PRS) based on a number of occupied resources in a dedicated resource pool for SL-PRS and a number of occupied resources by the UE. The UE is configured to perform at least one congestion control action for SL-PRS based on the at least one measurement.

### TECHNICAL FIELD

The present disclosure relates to wireless communications, and in particular, to congestion control for the positioning dedicated pool.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile user equipment (UE), as well as communication between network nodes and between UEs. The 3GPP is also developing standards for Sixth Generation (6G) wireless communication networks.

In upcoming 3GPP Release 18, solutions for sidelink (SL) ranging and positioning will be studied and standardized.

Previous standardization work for SL in 3GPP has focused on the communication aspects. From a positioning perspective, the network, such as via the network node, has a need of positioning within the cellular system.

### NR Positioning

NR currently supports the following examples of Radio Access Technology (RAT) Dependent positioning methods:

### DL-TDOA

The Downlink (DL) Time Difference of Arrival (TDOA) positioning method makes use of the DL Reference Signal Time Difference (RSTD) (and optionally DL Positioning Reference Signal (PRS) Received Signal Received Power (RSRP)) of downlink signals received from multiple Transmission Points (TPs), at the UE. The UE measures the DL RSTD (and optionally DL PRS RSRP) of the received signals using assistance data received from the positioning server, and the resulting measurements are used along with other configuration information to locate the UE in relation to the neighboring TPs.

### Multi-RTT

The Multi-Round Trip Time (Multi-RTT) positioning method makes use of the UE Receive-Transmit (Rx-Tx) measurements and DL PRS RSRP of downlink signals received from multiple Transmission/Reception Points (TRPs), measured by the UE and the measured network node Rx-Tx measurements and Uplink (UL) Sounding Reference Signal (SRS)-RSRP at multiple TRPs of uplink signals transmitted from UE.

### UL-TDOA

The UL TDOA positioning method makes use of the UL TDOA (and optionally UL SRS-RSRP) at multiple RPs of uplink signals transmitted from the UE. The RPs measure the UL TDOA (and optionally UL SRS-RSRP) of the received signals using assistance data received from the positioning server, and the resulting measurements are used along with other configuration information to estimate the location of the UE.

### DL-AoD

The DL Angle of Departure (AoD) positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

### UL-AoA

The UL Angle of Arrival (AoA) positioning method makes use of the measured azimuth and zenith of arrival at multiple reception points (RPs) of uplink signals transmitted from the UE. The RPs measure Azimuth-AoA (A-AoA) and Zenith-AoA (Z-AoA) of the received signals using assistance data received from the positioning server, and the resulting measurements are used along with other configuration information to estimate the location of the UE.

### NR-ECID

NR Enhanced Cell ID (NR E CID) positioning refers to techniques that use additional UE measurements and/or NR radio resource and other measurements to improve the UE location estimate.

The positioning modes can be categorized in below three areas:
Wireless-Device-Assisted: The UE performs measurements with or without assistance from the network and sends these measurements to the Evolved-Serving Mobile Location Center (E-SMLC) where the position calculation may take place.
Wireless-Device-Based: The UE performs measurements and calculates its own position with assistance from the network.
Standalone: The UE performs measurements and calculates its own without network assistance.
Wireless-Device-agnostic: the network performs measurements without UE assistance.

Positioning often relies on performing measurements on specific reference signals (RS), often referred to as positioning reference signals (PRS). The type and measurements and the different roles between transmitters and receivers (e.g., whether the UE/network node transmits/receives the PRS and/or performs measurements upon reception of the PRS) lead to the different positioning methods described above.

It may be desirable to have PRS span a large bandwidth, as this improves the resolution capabilities of the positioning measurements. At the same time, it may be desirable to multiplex the PRS transmitted by/to different nodes (e.g., UEs) for it increases the capacity of the system (i.e., the amount of users for which positioning services can be provided). Two mechanisms are typically used to have multiple PRS transmitted over the same bandwidth at the same time:
The use of orthogonal and pseudo-orthogonal sequences. That is, each PRS sequence is (pseudo) orthogonal to all the rest. By processing the received signals, it is possible to separate them even if they use the same time and frequency resources.
The use of combs, which consists of transmitting PRS every Nth resource element (RE). That is, a given PRS transmission occupies only some of the frequency resources in a given bandwidth (BW). This is illustrated in the example of FIG. 1, which shows PRS using two different combs.

### Sidelink Transmissions in NR

3GPP specified the LTE D2D (device-to-device) technology, also known as ProSe (Proximity Services) in the Release 12 and 13 of LTE. Later in Rel. 14 and 15, LTE V2X related enhancements targeting the specific characteristics of vehicular communications were specified. 3GPP had started a new work item (WI) in August 2018 within the scope of Rel. 16 to develop a new radio (NR) version of V2X communications. The NR V2X mainly targets advanced V2X services, which can be categorized into four use case groups: vehicles platooning, extended sensors, advanced driving and remote driving. The advanced V2X services would require enhancements of the NR system and a new NR sidelink framework could help to meet the stringent requirements in terms of latency and reliability. NR V2X system also expects to have higher system capacity and better coverage and to allow for an easy extension to support the future development of further advanced V2X services and other services.

Given the targeted services by NR V2X, it is commonly recognized that groupcast/multicast and unicast transmissions are desired, in which the intended receiver of a message consists of only a subset of the vehicles in proximity to the transmitter (groupcast) or of a single vehicle (unicast). For example, in the platooning service there are certain messages that are only of interest of the members of the platoon, making the members of the platoon a natural groupcast. In another example, the see-through use case most likely involves only a pair of vehicles, for which unicast transmissions naturally fit. Therefore, NR sidelink can support broadcast (as in LTE), groupcast and unicast transmissions. Furthermore, NR sidelink is designed in such a way that its operation is possible with and without network coverage and with varying degrees of interaction between the UEs and the network (NW) (e.g., via a network node), including support for standalone, network-less operation.

In 3GPP Rel. 17, National Security and Public Safety, NSPS, was considered to be one important use case, which can benefit from the already developed NR sidelink features in Rel. 16. Therefore, it is most likely that 3GPP will specify enhancements related to NSPS use case taking NR Rel. 16 sidelink as a baseline. Besides, in some scenarios NSPS services may need to operate with partial or w/o NW coverage, such as indoor firefighting, forest firefighting, earthquake rescue, sea rescue, etc. where the infrastructure is (partially) destroyed or not available, therefore, coverage extension may be an enabler for NSPS, for both NSPS services communicated between UE and cellular NW (e.g., via a network node) and that communicated between UEs over sidelink. In 3GPP Rel.17, study on NR sidelink relay was launched that aimed to further explore coverage extension for sidelink-based communication, including both UE to NW relay for cellular coverage extension and UE to UE relay for sidelink coverage extension. Currently, UE to NW relay is being considered. See, e.g., 3GPP Technical Report (TR) 37.985.

In the discussions and planning for NR 3GPP Rel. 18, sidelink based ranging and positioning has been agreed to be standardized. With ranging, this generally implies that both distance and angle information about the wireless link between two devices is derived. Distance ranging is today available in other standards, e.g., IEEE 802.4z, where in general, a signal exchange is taking place between two devices allowing the round-trip-time (RTT) to be calculated.

### SL Resource Allocation for Communication (Mode 2)

Two resource allocations modes for SL communications have been defined in NR: 1) Mode 1: the UE is in coverage and the network node is scheduling the resources that can be used by UE for SL communications, 2) Mode 2: the UE, which can be either in coverage or out of coverage, autonomously determines the transmission SL resources within SL resources configured by the network node or pre-configured by the network.

The Mode 2 resource allocation is specified in, e.g., in European Telecommunications Standards Institute (ETSI) Technical Specification (TS) 138 214 v17.4.0 section 8.1.4 and 3GPP TR 37.985 section 6.3.2.2 as below:
Mode 2 is for UE autonomous resource selection. Its basic structure is of a UE sensing, within a (pre-)configured resource pool, which resources are not in use by other UEs with higher-priority traffic, and choosing an appropriate amount of such resources for its own transmissions. Having selected such resources, the UE can transmit and re-transmit in them a certain number of times, or until a cause of resource reselection is triggered.

The mode 2 sensing procedure can select and then reserve resources for a variety of purposes reflecting that NR V2X introduces sidelink HARQ in support of unicast and groupcast in the physical layer. It may reserve resources to be used for a number of blind (re-)transmissions or HARQ-feedback-based (re-)transmissions of a transport block, in which case the resources are indicated in the SCI(s) scheduling the transport block.

Alternatively, it may select resources to be used for the initial transmission of a later transport block, in which case the resources are indicated in an SCI scheduling a current transport block, in a manner similar to the LTE-V2X scheme (clause 5.2.2.2). Finally, an initial transmission of a transport block can be performed after sensing and resource selection, but without a reservation.

The first-stage SCIs transmitted by UEs on PSCCH indicate the time-frequency resources in which the UE will transmit a PSSCH. These SCI transmissions are used by sensing UEs to maintain a record of which resources have been reserved by other UEs in the recent past. When a resource selection is triggered (e.g. by traffic arrival or a re-selection trigger), the UE considers a sensing window which starts at a (pre-)configured time in the past and ends shortly before the trigger time. The window can be either 1100 ms or 100 ms wide, with the intention that the 100 ms option is particularly useful for aperiodic traffic, and 1100 ms particularly for periodic traffic. A sensing UE also measures the SL-RSRP in the slots of the sensing window, which implies the level of interference which would be caused and experienced if the sensing UE were to transmit in them. In NR-V2X, SL-RSRP is a (pre-)configurable measurement of either PSSCH-RSRP or PSCCH-RSRP.

The sensing UE then selects resources for its (re-)transmission(s) from within a resource selection window. The window starts shortly after the trigger for (re-)selection of resources, and cannot be longer than the remaining latency budget of the packet due to be transmitted. Reserved resources in the selection window with SL-RSRP above a threshold are excluded from being candidates by the sensing UE, with the threshold set according to the priorities of the traffic of the sensing and transmitting UEs. Thus, a higher priority transmission from a sensing UE can occupy resources which are reserved by a transmitting UE with sufficiently low SL-RSRP and sufficiently lower-priority traffic.

If the set of resources in the selection window which have not been excluded is less than a certain proportion of the available resources within the window, the SL-RSRP exclusion threshold is relaxed in 3 dB steps. The proportion is set by (pre-)configuration to 20%, 35%, or 50% for each traffic priority. The UE selects an appropriate amount of resources randomly from this non-excluded set. The resources selected are not in general periodic. Up to three resources can be indicated in each SCI transmission, which can each be independently located in time and frequency. When the indicated resources are for semi-persistent transmission of another transport block, the range of supported periodicities is expanded compared to LTE-V2X, in order to cover the broader set of envisioned use cases in NR-V2X.

Shortly before transmitting in a reserved resource, a sensing UE re-evaluates the set of resources from which it can select, to check whether its intended transmission is still suitable, taking account of late-arriving SCIs due, typically, to an aperiodic higher-priority service starting to transmit after the end of the original sensing window. If the reserved resources would not be part of the set for selection at this time (T3), then new resources are selected from the updated resource selection window. The cut-off time T3 is long enough before transmission to allow the UE to perform the calculations relating to resource re-selection.

The timeline of the sensing and resource (re-)selection windows with respect to the time of trigger n, are shown in FIG. 6.3.2.2-2(a), and the effect of the possibility of re-evaluation before first use of the reservation in FIG. 6.3.2.2-2(b).

There are a number of triggers for resource re-selection, several of which are similar to LTE-V2X in Clause 5.2.2.2. In addition, there is the possibility to configure a resource pool with a pre-emption function designed to help accommodate aperiodic sidelink traffic, so that a UE reselects all the resources it has already reserved in a particular slot if another nearby UE with higher priority indicates it will transmit in any of them, implying a high-priority aperiodic traffic arrival at the other UE, and the SL-RSRP is above the exclusion threshold. The application of pre-emption can apply between all priorities of data traffic, or only when the priority of the pre-empting traffic is higher than a threshold and higher than that of the pre-empted traffic. A UE does not need to consider the possibility of pre-emption later than time T3 before the particular slot containing the reserved resources.

FIG. 6.3.2.2-1: Summary of sensing and resource (re-)selection procedures (reproduced as FIG. 2 herewith).

FIG. 6.3.2.2-2(a): Timeline of sensing and resource (re-)selection procedure triggered at time n, without re-evaluation before (m-T3). Its first reserved resource is at time m (reproduced as FIG. 3 herewith).

FIG. 6.3.2.2-2(b): Timeline of sensing and resource (re-)selection procedure originally triggered at time n, which has a first reserved resource at time m, when re-evaluation occurring at m-T3 determines the resources are no longer selectable. The new re-evaluation cut-off becomes (m′-T3) (reproduced as FIG. 4 herewith).

### 3GPP Release 18 WID on SL Positioning

The study phase of SL positioning and ranging in 3GPP Release 18 was finalized in 2022. The following includes objectives that were agreed to be covered, and as it can be seen, designing the SL PRS and its corresponding resource allocation are among the main objectives:
Specify solutions for support of sidelink positioning (including ranging) in. NR systems, including the following [RAN1, RAN2, RAN3, RAN4]:
   Specify SL PRS for support of sidelink positioning such that the SL PRS uses a comb-based (full RE mapping pattern is not precluded) frequency domain structure and a pseudorandom-based sequence where the existing sequence of DL-PRS is used as a starting point [RAN1].
      Specify support for SL PRS bandwidths of up to 100 MHz in FR1 spectrum.
      NOTE: SL PRS transmission in FR2 is not precluded but no FR2 specific aspects will be specified.
   Specify measurements to support RTT-type solutions using SL, SL-AoA, and SL-TDOA [RAN1, RAN2].
   Specify support of resource allocation for SL PRS:
      Including resource allocation Scheme 1 and Scheme 2, where Scheme 1 corresponds to a network-centric SL PRS resource allocation and Scheme 2 corresponds to UE autonomous SL PRS resource allocation [RAN1].
For resource allocation mechanism for SL PRS in Scheme 2:
   Study and specify support of sensing-based resource allocation, and/or a random resource selection [RAN1].
   Study and specify solutions for congestion control for SL PRS and/or inter-UE coordination for SL-PRS [RAN1].
      Support resource allocation for shared resource pool with Release 16/17/18 sidelink communication and dedicated resource pool for SL PRS [RAN1].
NOTE: For SL positioning resource (pre-)configuration in a shared resource pool with Release 16/17/18 sidelink communication, backward compatibility with legacy Release 16/17 UEs should be ensured.
   Specify procedures for transmit power control for SL PRS transmissions at least based on open loop power control (OLPC) [RAN1].
   Specify signaling and associated UE behavior for support of unicast, groupcast (not including many to one) and broadcast of SL PRS transmissions [RAN1, RAN2].
   Specify reporting signaling and procedures to facilitate support of SL positioning in all coverage scenarios and for PC5-only and joint PC5-Uu scenarios [RAN2, RAN3]:
      Specify the protocol and procedures for SL positioning between UEs (Protocol for Sidelink positioning procedures (SLPP)).
      Specify the protocol and procedures for SL positioning between UEs and LMF.
   Specify signaling to NG-RAN for sidelink positioning and ranging service authorizations as needed. [RAN3, RAN2]
   Specify corresponding new core requirements, as well as identifying and specify the impact on the existing RAN4 specification, including RRM measurements and procedures [RAN4].

### Congestion Control

Congestion control mechanism is developed to deal with the situation when the channel is overloaded, e.g., as specified in ETSI TS 103 547. There are two metrics introduced for SL congestion control: Channel busy ratio (CBR) and channel occupancy ratio (CR).

The SL CR measures the fraction of the available resources that are used by a UE for performing its own SL transmissions. Such measurement is a generalization (over time and frequency) of a duty cycle (typically defined only over time).

The SL CBR measures, from the perspective of a first UE, the fraction of the available resources that are used by other UEs for their own transmissions. A resource is considered to be used by another UE if the received signal strength indicator (RSSI) exceeds a given threshold.

The definitions of SL CR and SL CBR can be found, e.g., in 3GPP TS 38.215, but are provided below for convenience and ease of understanding:
5.1.26 Sidelink channel occupancy ratio (SL CR)
Definition Sidelink Channel Occupancy Ratio (SL CR) evaluated at slot n is defined as the total number of sub-channels used for its transmissions in slots [n−a, n−1] and granted in slots [n, n+b] divided by the total number of configured sub-channels in the transmission pool over [n−a, n+b].
Applicable for RRC_IDLE intra-frequency,
RRC_IDLE inter-frequency,
RRC_CONNECTED intra-frequency,
RRC_CONNECTED inter-frequency
NOTE 1: a is a positive integer and b is 0 or a positive integer; a and b are determined by UE implementation with a+b+1=1000 or 1000·2μ slots, according to higher layer parameter sl-TimeWindowSizeCR, b< (a+b+1)/2, and n+b shall not exceed the last transmission opportunity of the grant for the current transmission.
NOTE 2: SL CR is evaluated for each (re) transmission.
NOTE 3: In evaluating SL CR, the UE shall assume the transmission parameter used at slot n is reused according to the existing grant(s) in slot [n+1, n+b] without packet dropping.
NOTE 4: The slot index is based on physical slot index.
NOTE 5: SL CR can be computed per priority level
NOTE 6: A resource is considered granted if it is a member of a selected sidelink grant as defined in TS 38.321 [7].
5.1.27 Sidelink channel busy ratio (SL CBR)
Definition SL Channel Busy Ratio (SL CBR) measured in slot n is defined as the portion of sub-channels in the resource pool whose SL RSSI measured by the UE exceed a (pre-)configured threshold sensed over a CBR measurement window [n−a, n−1], wherein a is equal to 100 or 100·2μ slots, according to higher layer parameter sl-TimeWindowSizeCBR. When UE is configured to perform partial sensing by higher layers (including when SL DRX is configured), SL RSSI is measured in slots where the UE performs partial sensing and where the UE performs PSCCH/PSSCH reception within the CBR measurement window. The calculation of SL CBR is limited within the slots for which the SL RSSI is measured. If the number of SL RSSI measurement slots within the CBR measurement window is below a (pre-)configured threshold, a (pre-)configured SL CBR value is used.
Applicable for RRC_IDLE intra-frequency,
RRC_IDLE inter-frequency,
RRC_CONNECTED intra-frequency,
RRC_CONNECTED inter-frequency
NOTE 1: The slot index is based on physical slot index.

These two measurements are defined per transmission pool. In addition, CR may be computed per priority level.

A UE can utilize these two parameters to determine if it needs to adjust its transmission in order to balance the channel load. This can be achieved through the use of a look up table, which considers a maximum level and limit for CR based on the different ranges of the CBR. The UE cannot exceed this value. For each transmission, it must evaluate whether it surpasses this limit. If the UE does exceed this value, it will modify its transmission parameters accordingly. As an example, FIG. 5 is the look up table from ETSI TS 103 574 and shows the CBR ranges and the corresponding CR limits.

The actions taken by the UE to ensure that the congestion control limits are sometimes left up to UE implementation. That is, the UE must meet the congestion control limits, but whether to drop packets, reduce rate of transmission, increase spectral efficiency, etc. is decided by the UE. The corresponding requirements are specified in, e.g., 3GPP TS 38.214. We copy them below for convenience:
8.1.6 Sidelink congestion control in sidelink resource allocation mode 2
If a UE is configured with higher layer parameter sl-CR-Limit and transmits PSSCH in slot n, the UE shall ensure the following limits for any priority value k;

$$\sum \_ ( i \geq k ) \text{?} CR ( i ) \leq CR Limit \qquad ( k )$$

where CR(i) is the CR evaluated in slot n-N for the PSSCH transmissions with ‘Priority’ field in the SCI set to i, and CR_Limit (k) corresponds to the high layer parameter sl-CR-Limit that is associated with the priority value k and the CBR range which includes the CBR measured in slot n-N, where N is the congestion control processing time.

The congestion control processing time N is based on u of Table 8.1.6-1 and Table 8.1.6-2 for UE processing capability 1 and 2 respectively, where u corresponds to the subcarrier spacing of the sidelink channel with which the PSSCH is to be transmitted. A UE shall only apply a single processing time capability in sidelink congestion control.

TABLE 8.1.6-1
Congestion control processing time for processing
timing capability 1

| | Congestion |
|---|---|
| | control processing |
| μ | time N [slots] |
| 0 | 2 |
| 1 | 2 |
| 2 | 4 |
| 3 | 8 |

TABLE 8.1.6-2
Congestion control processing time for processing
timing capability 2

| | Congestion |
|---|---|
| | control processing |
| μ | time N [slots] |
| 0 | 2 |
| 1 | 4 |
| 2 | 8 |
| 3 | 16 |

It is up to those involved with UE implementation to determine how to meet the above limits, including dropping the transmissions in slot n.

### SUMMARY

Some embodiments advantageously provide methods, systems, and apparatuses for congestion control for the positioning dedicated pool.

When introducing the SL positioning in Release 18, an objective is to design procedures related to the SL PRS transmission in the dedicated pool. This includes resource allocation in scenarios without network involvement, and the congestion control mechanism when there are many UEs attempting to transmit SL-PRS.

The current congestion metrics for NR SL are based on the sub-channels, and the control mechanisms are designed for communication and the transport block (TB) transmissions. However, for an SL-PRS transmission, depending on the configured comb size, the UEs' transmission may only occupy a few numbers of REs in a subchannel. Existing mechanisms for congestion control for data transmissions are therefore not optimized for the new use case of PRS transmissions. The introduction of a new dedicated pool for positioning, dedicated for transmission of the SL PRS, allows defining of more efficient metrics and procedures for the congestion control of PRS transmission.

The present disclosure describes an NR SL congestion control mechanism on dedicated pool for SL PRS transmission. This redefines the metrics to measure the congestion specifically for SL PRS transmission and introduces new procedures that a UE can perform to adjust its transmission load.

The present disclosure also describes a solution that enables efficient mechanism for congestion control specifically for the positioning dedicated pool based on the characteristics of the SL-PRS. It also proposes steps that a UE can follow to adjust its transmission based on its previous transmissions and the transmission load of the pool.

SL PRS and the corresponding positioning dedicated pool are referenced herein as a non-limiting example of a reference signal (and its corresponding dedicated pool) that needs a modified congestion control mechanism.

Various embodiments described herein pertain to a mechanism to adjust the load of the transmission of SL or SL PRS in a SL pool (dedicated or shared). This enables a more efficient congestion measurement and control of the pool based on the SL-PRS parameters.

Various embodiments described may enable UEs to have fair and efficient access to the resources without causing congestion in the dedicated pool.

According to one aspect of the present disclosure, a UE configured to communicate with another device is provided. The UE is configured to perform at least one measurement according to a sidelink positioning reference signaling, SL PRS, resource element configuration; and perform at least one congestion control action for SL-PRS based on the at least one measurement.

According to one or more embodiments of this aspect, the at least one measurement is based on a number of occupied resource elements in a resource pool dedicated for SL-PRS.

According to one or more embodiments of this aspect, the at least one measurement is based on a number of occupied resource elements that are occupied by the UE.

According to one or more embodiments of this aspect, the at least one measurement is based on a number of SL PRS combs that have been used in a resource pool.

According to one or more embodiments of this aspect, the at least one measurement is based on a number of SL PRS combs that have been used by the UE.

According to one or more embodiments of this aspect, the at least one measurement is based on a number of occupied resource elements during a predetermined time interval.

According to one or more embodiments of this aspect, the at least one measurement is performed on a per sub-channel basis and re-scaled based on an offset. According to one or more embodiments of this aspect, the at least one measurement is based on a granularity of a resource reservation for SL PRS.

According to one or more embodiments of this aspect, the at least one measurement is at least one of a channel busy ration, CBR, and channel occupancy ration, CR.

According to one or more embodiments of this aspect, the at least one congestion control action includes adjusting an SL PRS configuration.

According to one or more embodiments of this aspect, the SL PRS configuration includes adjusting a utilization in time of radio resources for transmission of SL PRS.

According to one or more embodiments of this aspect, adjusting the utilization in time of radio resources includes adjusting at least one of a peridocity of transmission, a transmission rate, and how often SL PRS transmissions are performed.

According to one or more embodiments of this aspect, adjusting an SL PRS configuration includes adjusting a utilization in frequency of radio resources for transmission of SL PRS.

According to one or more embodiments of this aspect, adjusting the utilization in frequency of radio resources includes adjusting at least one of a number of resource elements used per SL PRS transmission, a comb size, and a bandwidth allocation.

According to another aspect of the present disclosure, a method performed by a UE configured to communicate with another device is provided. The method includes: performing at least one measurement according to a sidelink positioning reference signaling, SL PRS, resource element configuration; and performing at least one congestion control action for SL-PRS based on the at least one measurement.

According to one or more embodiments of this aspect, the at least one measurement is based on a number of occupied resource elements in a resource pool dedicated for SL-PRS.

According to one or more embodiments of this aspect, the at least one measurement is based on a number of occupied resource elements that are occupied by the UE.

According to one or more embodiments of this aspect, the at least one measurement is based on a number of SL PRS combs that have been used in a resource pool.

According to one or more embodiments of this aspect, the at least one measurement is based on a number of SL PRS combs that have been used by the UE.

According to one or more embodiments of this aspect, the at least one measurement is based on a number of occupied resource elements during a predetermined time interval.

According to one or more embodiments of this aspect, the at least one measurement is performed on a per sub-channel basis and re-scaled based on an offset.

According to one or more embodiments of this aspect, the at least one measurement is based on a granularity of a resource reservation for SL PRS.

According to one or more embodiments of this aspect, the at least one measurement is at least one of a channel busy ration, CBR, and channel occupancy ration, CR.

According to one or more embodiments of this aspect, the at least one congestion control action includes adjusting an SL PRS configuration.

According to one or more embodiments of this aspect, the SL PRS configuration includes adjusting a utilization in time of radio resources for transmission of SL PRS.

According to one or more embodiments of this aspect, adjusting the utilization in time of radio resources includes adjusting at least one of a peridocity of transmission, a transmission rate, and how often SL PRS transmissions are performed.

According to one or more embodiments of this aspect, adjusting an SL PRS configuration includes adjusting a utilization in frequency of radio resources for transmission of SL PRS.

According to one or more embodiments of this aspect, adjusting the utilization in frequency of radio resources includes adjusting at least one of a number of resource elements used per SL PRS transmission, a comb size, and a bandwidth allocation.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of PRS using two different combs;

FIG. 2 is a diagram of sensing and resource (re-)selection procedures;

FIG. 3 is a diagram of sensing and resource (re-)selection procedures;

FIG. 4 is a diagram of sensing and resource (re-)selection procedures

FIG. 5 is a table of CBR ranges and the corresponding CR limits;

FIG. 6 is a schematic diagram of an example network architecture illustrating a communication system connected via an intermediate network to a host computer according to the principles in the present disclosure;

FIG. 7 is a block diagram of a host computer communicating via a network node with a UE over an at least partially wireless connection according to some embodiments of the present disclosure;

FIG. 8 is a flowchart illustrating example methods implemented in a communication system including a host computer, a network node and a UE for executing a client application at a UE according to some embodiments of the present disclosure;

FIG. 9 is a flowchart illustrating example methods implemented in a communication system including a host computer, a network node and a UE for receiving user data at a UE according to some embodiments of the present disclosure;

FIG. 10 is a flowchart illustrating example methods implemented in a communication system including a host computer, a network node and a UE for receiving user data from the UE at a host computer according to some embodiments of the present disclosure;

FIG. 11 is a flowchart illustrating example methods implemented in a communication system including a host computer, a network node and a UE for receiving user data at a host computer according to some embodiments of the present disclosure;

FIG. 12 is a flowchart of an example process in a UE according to some embodiments of the present disclosure;

FIG. 13 is a flowchart of another example process in a UE according to some embodiments of the present disclosure;

FIG. 14 is a diagram of resource pool according to some embodiments of the present disclosure; and

FIG. 15 is a diagram of resource pool according to some embodiments of the present disclosure.

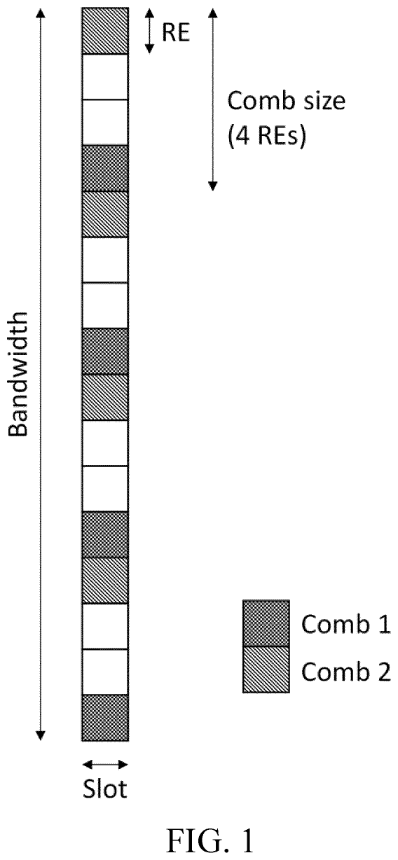

### DETAILED DESCRIPTION

Before describing in detail example embodiments, it is noted that the embodiments reside primarily in combinations of apparatus components and processing steps related to congestion control for the positioning dedicated pool. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a user equipment (UE) such as a wireless device (WD) or a radio network node.

In some embodiments, the non-limiting terms wireless device (WD) or a user equipment (UE) are used interchangeably. The UE herein can be any type of wireless device capable of communicating with a network node or another UE over radio signals, such as wireless device (WD). The UE may also be a radio communication device, target device, device to device (D2D) WD, machine type WD or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B, or one or both of A and B. In some embodiments, at least one of A, B and C corresponds to one or more of A, B and C, and/or A, B, C or a combination thereof.

Note further, that functions described herein as being performed by a UE or a network node may be distributed over a plurality of UEs and/or network nodes. In other words, it is contemplated that the functions of the network node and UE described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

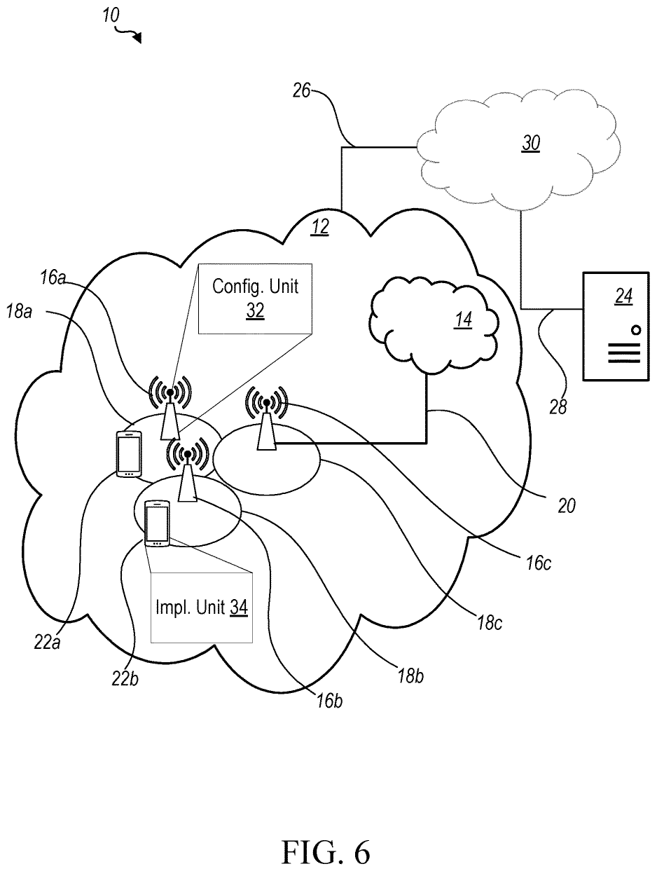

Some embodiments provide congestion control for the positioning dedicated pool. Referring again to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first UE 22a located in coverage area 18a is configured to wirelessly connect to, or be paged by, the corresponding network node 16a. A second UE 22b in coverage area 18b is wirelessly connectable to the corresponding network node 16b. Of note, it is contemplated that UE 22a and UE 22b can also be in proximity to one another to engage in sidelink communications, either directly or via a sidelink relay node. In other words, implementations are not limited to UE 22a and UE 22b being in different coverage areas 18. While a plurality of UEs 22a, 22b (collectively referred to as UEs 22) are illustrated in this example, the disclosed embodiments are equally applicable to a situation where a sole UE is in the coverage area or where a sole UE is connecting to the corresponding network node 16. Note that although only two UEs 22 and three network nodes 16 are shown for convenience, the communication system may include many more UEs 22 and network nodes 16.

Also, it is contemplated that a UE 22 can be in simultaneous communication and/or configured to separately communicate with more than one network node 16 and more than one type of network node 16. For example, a UE 22 can have dual connectivity with a network node 16 that supports LTE and the same or a different network node 16 that supports NR. As an example, UE 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 6 as a whole enables connectivity between one of the connected UEs 22a, 22b and the host computer 24. The connectivity may be described as an over-the-top (OTT) connection. The host computer 24 and the connected UEs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected UE 22a. Similarly, the network node 16 need not be aware of the future routing of an outgoing uplink communication originating from the UE 22a towards the host computer 24.

A network node 16 is configured to include a configuration unit 32 which is configured to perform one or more network node 16 functions described herein, including functions related to congestion control for the positioning dedicated pool. A UE 22 is configured to include an implementation unit 34 which is configured to perform one or more UE 22 functions described herein, including functions related to congestion control for the positioning dedicated pool.

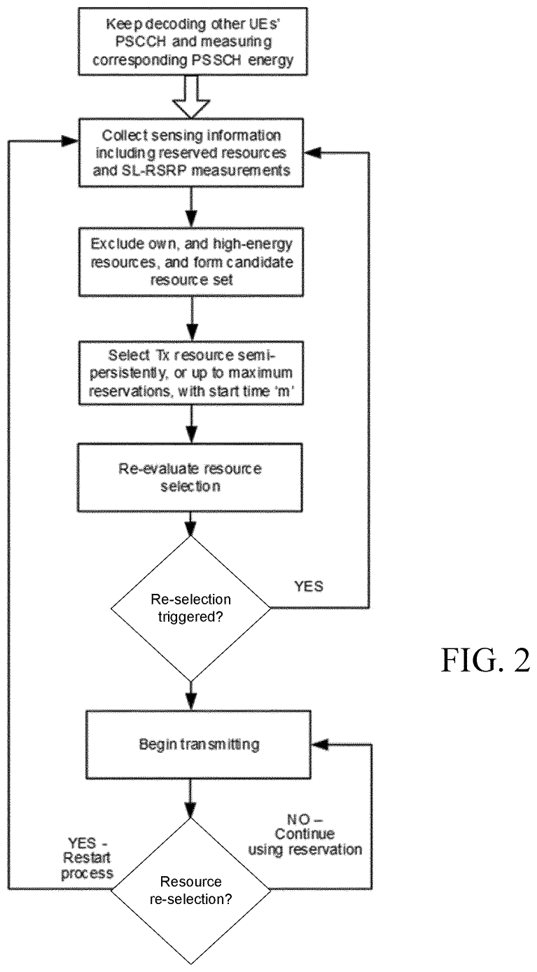

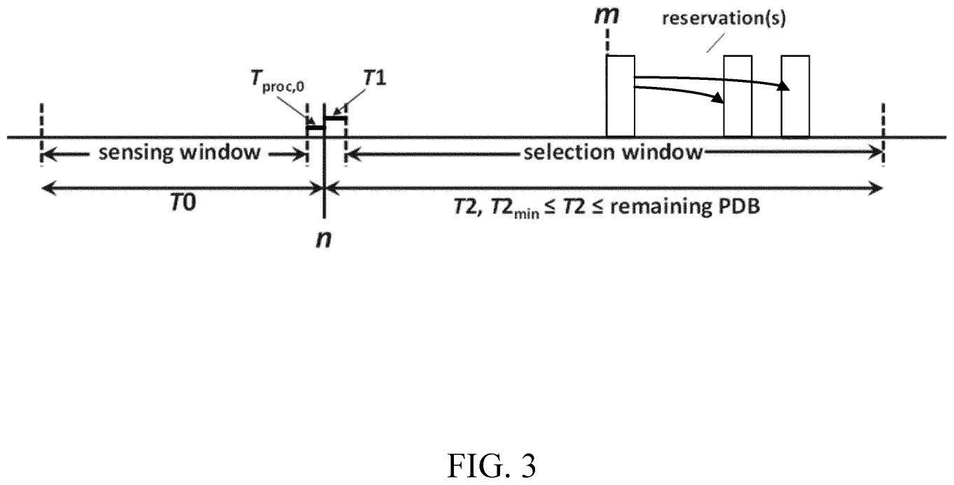

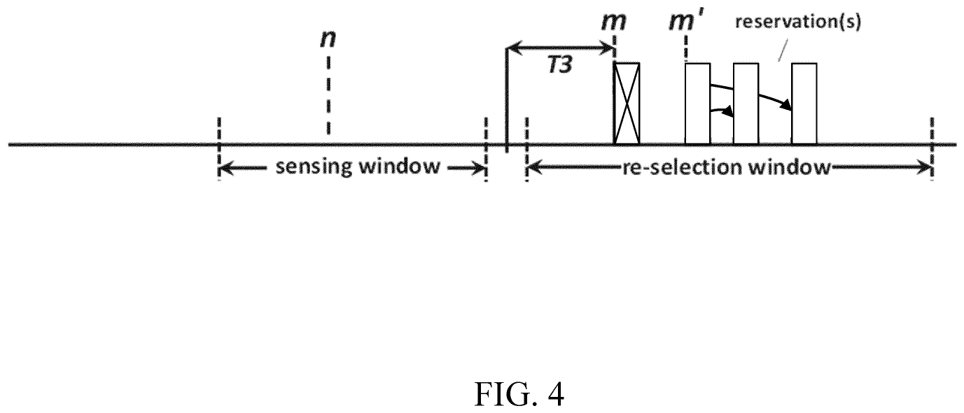

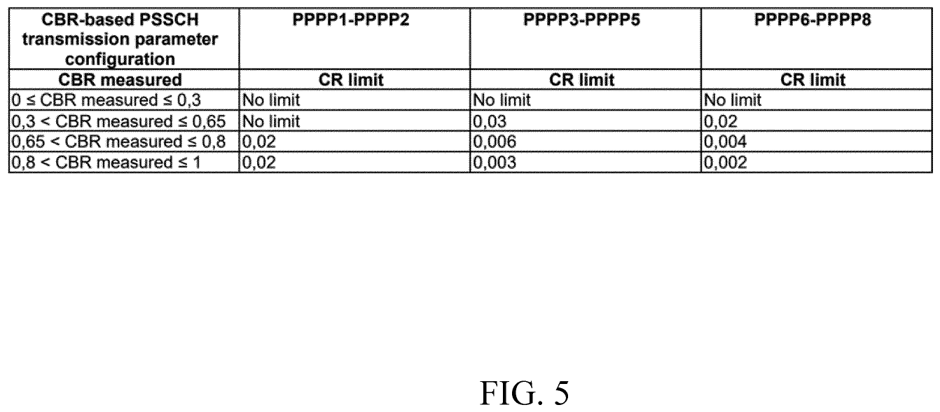

Example implementations, in accordance with an embodiment, of the UE 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a UE 22 connecting via an OTT connection 52 terminating at the UE 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the UE 22. The processing circuitry 42 of the host computer 24 may include a control unit 54 configured to enable the service provider to observe/monitor/control/transmit to/receive from the network node 16 and/or the UE 22.

The communication system 10 further includes a network node 16 provided in a communication system 10 and including hardware 58 enabling it to communicate with the host computer 24 and with the UE 22. The hardware 58 may include a communication interface 60 for setting up and maintaining a wired or wireless connection with an interface of a different communication device of the communication system 10, as well as a radio interface 62 for setting up and maintaining at least a wireless connection 64 with a UE 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform one or more network node 16 functions described herein, including functions related to congestion control for the positioning dedicated pool.

The communication system 10 further includes the UE 22 already referred to. The UE 22 may have hardware 80 that may include a radio interface 82 configured to set up and maintain a wireless connection 64 with a network node 16 serving a coverage area 18 in which the UE 22 is currently located. The radio interface 82 may be formed as or may include, for example, one or more RF transmitters, one or more RF receivers, and/or one or more RF transceivers.

The hardware 80 of the UE 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 22 may further comprise software 90, which is stored in, for example, memory 88 at the UE 22, or stored in external memory (e.g., database, storage array, network storage device, etc.) accessible by the UE 22. The software 90 may be executable by the processing circuitry 84. The software 90 may include a client application 92. The client application 92 may be operable to provide a service to a human or non-human user via the UE 22, with the support of the host computer 24. In the host computer 24, an executing host application 50 may communicate with the executing client application 92 via the OTT connection 52 terminating at the UE 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by UE 22. The processor 86 corresponds to one or more processors 86 for performing UE 22 functions described herein. The UE 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to UE 22. For example, the processing circuitry 84 of the UE 22 may include an implementation unit 34 configured to perform one or more UE 22 functions described herein, including functions related to congestion control for the positioning dedicated pool

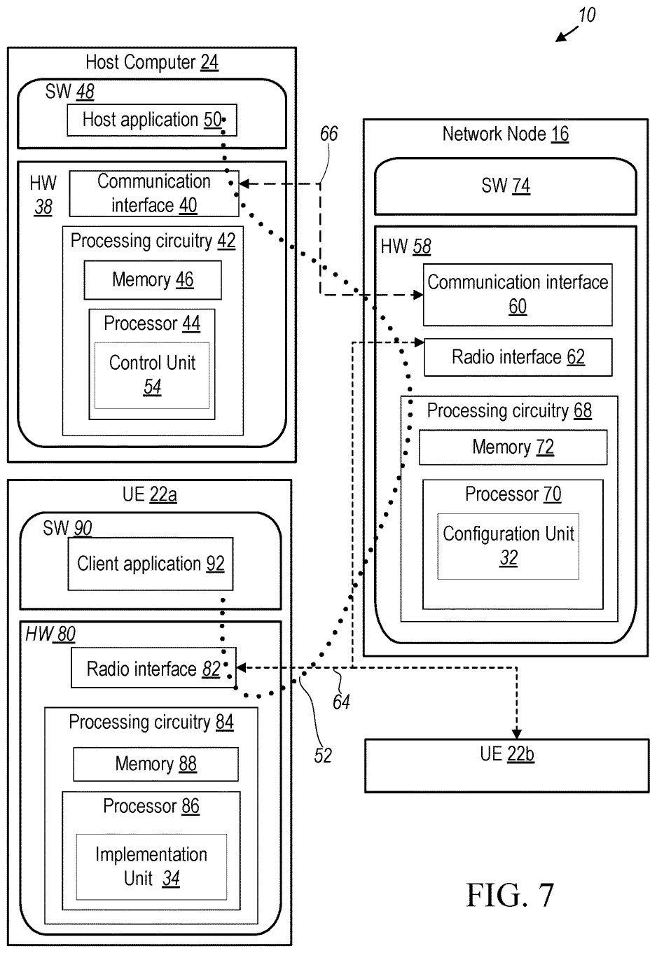

In some embodiments, the inner workings of the network node 16, UE 22, and host computer 24 may be as shown in FIG. 7 and independently, the surrounding network topology may be that of FIG. 6.

In FIG. 7, the OTT connection 52 has been drawn abstractly to illustrate the communication between the host computer 24 and the UE 22 via the network node 16, without explicit reference to any intermediary devices and the precise routing of messages via these devices. Network infrastructure may determine the routing, which it may be configured to hide from the UE 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the UE 22, e.g., UE 22a, and the network node 16 is in accordance with the teachings of the embodiments described throughout this disclosure. In addition, a UE 22, e.g., UE 22a may be in direct wireless communication with another UE 22, e.g., UE 22b, over a wireless connection 64 such as may be used in, e.g., a sidelink communication in accordance with present disclosure. One or more of the various embodiments improve the performance of OTT services provided to the UE 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and UE 22, in response to variations in the measurement results. The measurement procedure and/or the network functionality for reconfiguring the OTT connection 52 may be implemented in the software 48 of the host computer 24 or in the software 90 of the UE 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary UE signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the UE 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the UE 22, and/or preparing/terminating/maintaining/supporting/ending in receipt of a transmission from the UE 22.

In some embodiments, the host computer 24 includes processing circuitry 42 and a communication interface 40 that is configured to a communication interface 40 configured to receive user data originating from a transmission from a UE 22 to a network node 16. In some embodiments, the UE 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as configuration unit 32, and implementation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

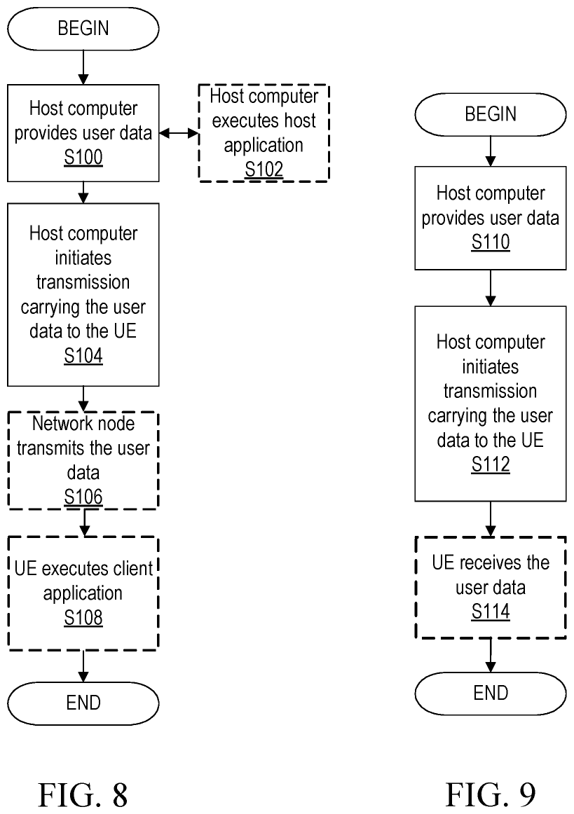

FIG. 8 is a flowchart illustrating an example method implemented in a communication system, such as, for example, the communication system of FIGS. 6 and 7, in accordance with one embodiment. The communication system may include a host computer 24, a network node 16 and a UE 22, which may be those described with reference to FIG. 7. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the UE 22 (Block S104). In an optional third step, the network node 16 transmits to the UE 22 the user data which was carried in the transmission that the host computer 24 initiated, in accordance with the teachings of the embodiments described throughout this disclosure (Block S106). In an optional fourth step, the UE 22 executes a client application, such as, for example, the client application 92, associated with the host application 50 executed by the host computer 24 (Block S108).

FIG. 9 is a flowchart illustrating an example method implemented in a communication system, such as, for example, the communication system of FIG. 6, in accordance with one embodiment. The communication system may include a host computer 24, a network node 16 and a UE 22, which may be those described with reference to FIGS. 6 and 7. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the UE 22 (Block S112). The transmission may pass via the network node 16, in accordance with the teachings of the embodiments described throughout this disclosure. In an optional third step, the UE 22 receives the user data carried in the transmission (Block S114).

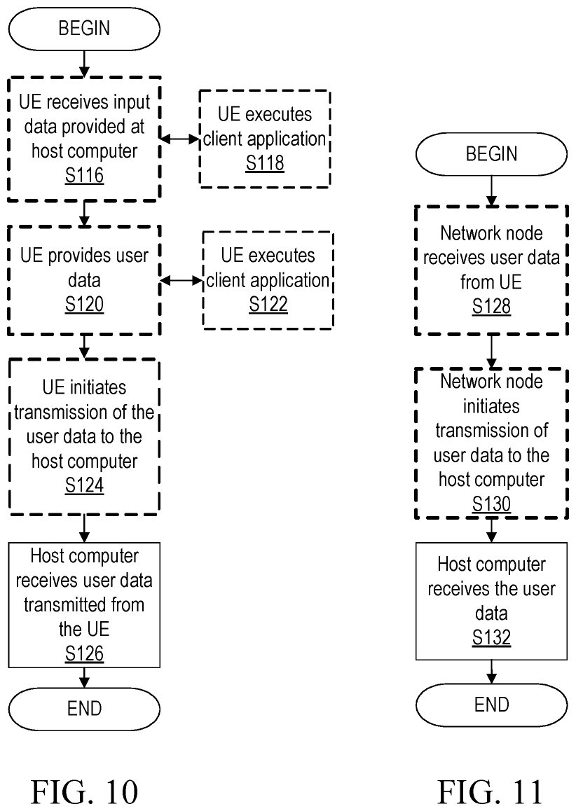

FIG. 10 is a flowchart illustrating an example method implemented in a communication system, such as, for example, the communication system of FIG. 6, in accordance with one embodiment. The communication system may include a host computer 24, a network node 16 and a UE 22, which may be those described with reference to FIGS. 6 and 7. In an optional first step of the method, the UE 22 receives input data provided by the host computer 24 (Block S116). In an optional substep of the first step, the UE 22 executes the client application 92, which provides the user data in reaction to the received input data provided by the host computer 24 (Block S118). Additionally or alternatively, in an optional second step, the UE 22 provides user data (Block S120). In an optional substep of the second step, the UE provides the user data by executing a client application, such as, for example, client application 92 (Block S122). In providing the user data, the executed client application 92 may further consider user input received from the user. Regardless of the specific manner in which the user data was provided, the UE 22 may initiate, in an optional third substep, transmission of the user data to the host computer 24 (Block S124). In a fourth step of the method, the host computer 24 receives the user data transmitted from the UE 22, in accordance with the teachings of the embodiments described throughout this disclosure (Block S126).

FIG. 11 is a flowchart illustrating an example method implemented in a communication system, such as, for example, the communication system of FIG. 6, in accordance with one embodiment. The communication system may include a host computer 24, a network node 16 and a UE 22, which may be those described with reference to FIGS. 6 and 7. In an optional first step of the method, in accordance with the teachings of the embodiments described throughout this disclosure, the network node 16 receives user data from the UE 22 (Block S128). In an optional second step, the network node 16 initiates transmission of the received user data to the host computer 24 (Block S130). In a third step, the host computer 24 receives the user data carried in the transmission initiated by the network node 16 (Block S132).

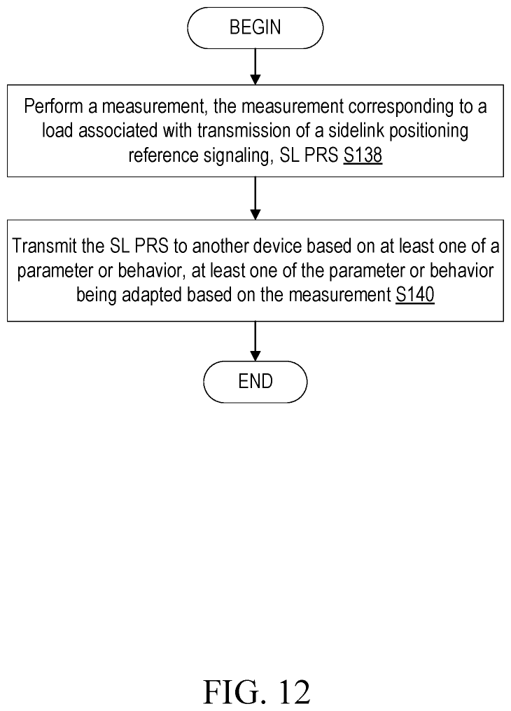

FIG. 12 is a flowchart of an example process in a UE 22 according to some embodiments of the present disclosure. One or more blocks described herein may be performed by one or more elements of UE 22 such as by one or more of processing circuitry 84 (including the implementation unit 34), processor 86, radio interface 82 and/or communication interface 60. UE is configured to perform a measurement, the measurement corresponding to a load associated with transmission of a sidelink positioning reference signaling, SL PRS (Block S138). UE is configured to transmit the SL PRS to another device using at least one of a parameter or behavior, at least one of the parameter or behavior being adapted based on the measurement (Block S140).

In at least one embodiment, the transmission of the SL PRS is based on a lookup table of a plurality of channel busy radio, CBR, ranges and channel occupancy ratio, CR, limits.

In at least one embodiment, the parameter includes a channel busy radio, CBR, parameter, and the CBR parameter is determined based on at least one of a received signal strength indicator (RSSI) and a reference signal received power, RSRP.

In at least one embodiment, adapting the behavior includes at least one of: selecting a positioning dedicated pool; selecting a shared pool; adjusting a transmission load; dropping an SL PRS transmission; and participating in a positioning procedure based on whether the UE can offer a required quality of service, QoS.

In at least one embodiment, the other device is another UE 22. In at least one embodiment, the other device is a network node 16. In other words, “device” as referred to herein can be a UE 22 or a network node 16. For example, the device might be a network node 16 if the resource allocation mode for SL communication is Mode 1 and might be another UE 22 if the resource allocation mode for SL communication is Mode 2.

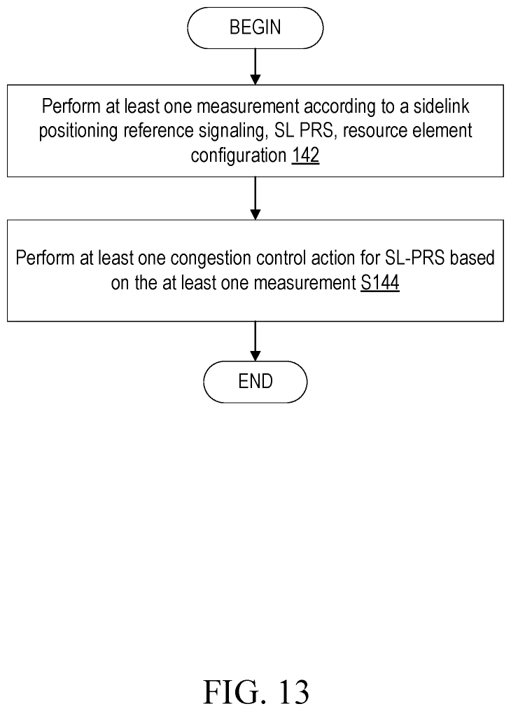

FIG. 13 is a flowchart of another example process in a UE 22 according to some embodiments of the present disclosure. One or more blocks described herein may be performed by one or more elements of UE 22 such as by one or more of processing circuitry 84 (including the implementation unit 34), processor 86, radio interface 82 and/or communication interface 60. UE 22 is configured to perform at least one measurement according to a sidelink positioning reference signaling, SL PRS, resource element configuration (Block S142). UE 22 is configured to perform at least one congestion control action for SL-PRS based on the at least one measurement (Block S144).

In at least one embodiment, the at least one measurement is based on a number of occupied resource elements in a resource pool dedicated for SL-PRS.

In at least one embodiment, the at least one measurement is based on a number of occupied resource elements that are occupied by the UE 22.

In at least one embodiment, the at least one measurement is based on a number of SL PRS combs that have been used in a resource pool.

In at least one embodiment, the at least one measurement is based on a number of SL PRS combs that have been used by the UE 22.

In at least one embodiment, the at least one measurement is based on a number of occupied resource elements during a predetermined time interval.

In at least one embodiment, the at least one measurement is performed on a per sub-channel basis and re-scaled based on an offset.

In at least one embodiment, the at least one measurement is based on a granularity of a resource reservation for SL PRS.

In at least one embodiment, the at least one measurement is at least one of a channel busy ration, CBR, and channel occupancy ration, CR.

In at least one embodiment, the at least one congestion control action comprises adjusting an SL PRS configuration.

In at least one embodiment, the SL PRS configuration comprises adjusting a utilization in time of radio resources for transmission of SL PRS.

In at least one embodiment, adjusting the utilization in time of radio resources comprises adjusting at least one of a peridocity of transmission, a transmission rate, and how often SL PRS transmissions are performed.

In at least one embodiment, adjusting an SL PRS configuration comprises adjusting a utilization in frequency of radio resources for transmission of SL PRS.

In at least one embodiment, adjusting the utilization in frequency of radio resources comprises adjusting at least one of a number of resource elements used per SL PRS transmission, a comb size, and a bandwidth allocation.

Having described the general process flow of arrangements of the disclosure and having provided examples of hardware and software arrangements for implementing the processes and functions of the disclosure, the sections below provide details and examples of arrangements for congestion control for the positioning dedicated pool. One or more UE 22 functions described below may be performed by one or more of processing circuitry 84, processor 86, implementation unit 34, etc. One or more network node 16 functions described below may be performed by one or more of processing circuitry 68, processor 70, configuration unit 32, etc.

Various embodiments include the following two parts:
Performing a measurement that is specific for assessing the load associated with transmission of SL PRS.
Adapting a parameter or behavior related to the transmission of SL PRS in response to the measurement performed.

These two parts realize congestion control for SL PRS. The first part is the measurement part, the second part is the transmitter adaptation part.

In at least one embodiment, congestion control for SL communications and for SL PRS may be performed separately. That is, a new congestion control mechanism is introduced for SL PRS. This may be used for example, for transmission of SL PRS in a dedicated pool.

In at least one embodiment, a new look up table corresponding to CBR ranges and CR limits can be considered for the SL PRS transmission and the corresponding positioning dedicated pool.

In at least one embodiment, the same congestion control may be used for SL communications and SL PRS. This may be applicable for the case of a shared pool for both SL communications and SL PRS. To allow for this, SL PRS measurements may be given a (pre-)configured level of priority so that the existing procedures can be reutilized.

### Congestion Control Measurements and Parameters

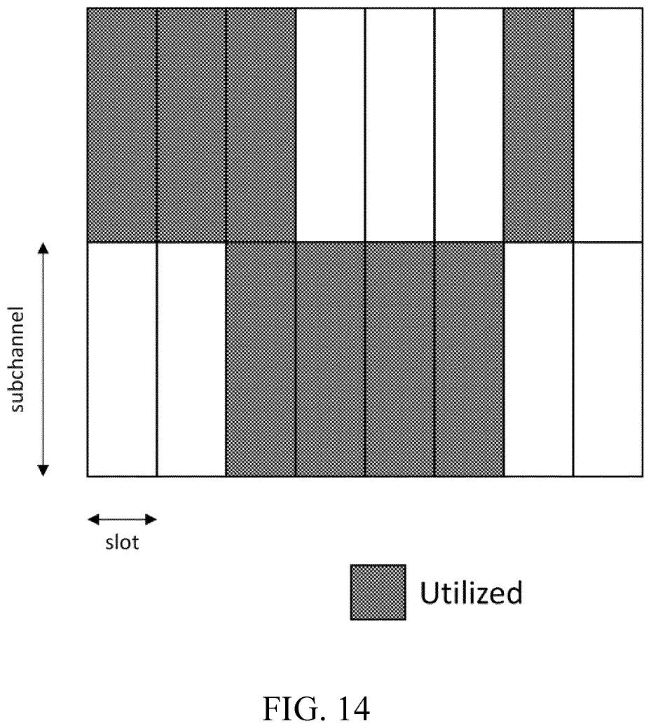

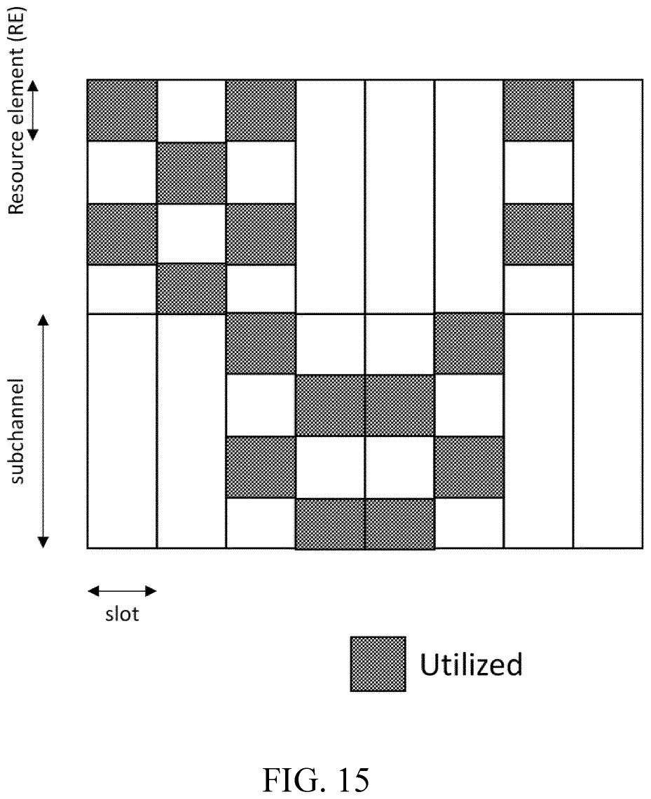

The CR and CBR parameters have been defined for SL data communication and both of them are using the sub-channels as the granularity of the measurements. However, for the PRS transmission, a UE 22 may use only a few numbers of the REs in a subchannel. Therefore, the current metrics may not be a good representative of the resources that a specific UE 22 is using for the transmission of the PRS. This problem may be even more pronounced for the larger comb sizes, for which only a small fraction of the REs in a sub-channel may be used for transmission of a SL PRS comb. So, it may be necessary to redefine these parameters for the transmission of the SL PRS and the positioning dedicated pool. This issue is illustrated in FIG. 14 and FIG. 15.

FIG. 14 shows a resource pool where half of the resource are perceived as utilized (utilized resources are darkened) by a first UE 22. That is, it measures an RSSI value above a certain threshold in those resources. For that resource pool, the CBR measurement is 0.5 or 50%.

FIG. 15 shows a resource pool where one fourth of the resources are utilized (utilized resources are darkened). However, half of the sub-channels would be seen as utilized with the existing approach to measuring.

Of note, FIG. 14 shows the same resource pool as FIG. 15. However, in this case only half of the REs are in use in those sub-channels that are utilized. Existing/legacy measurements would still result in a CBR measurement of 0.5 or 50%. However, the real occupation is just 0.25 or 25%.

A given RE may be used by multiple SL PRS sequences that can be separated through the use of some orthogonal code (e.g., a cyclic shift). So, measuring RSSI on specific resources may not be suitable either.

CR and CBR measurements reflection SL PRS may be redefined in any of the following ways:
CBR and/or CR are measured based on the number of the REs that have been occupied in the pool and by the measuring UE 22, respectively (over a certain interval).
CBR and/or CR are measured based on the number of SL PRS combs that have been used in the pool and by the measuring UE 22, respectively (over a certain interval).
CBR and/or CR are measured based on per sub-channel, but the resulting measurement is re-scaled according to an offset. For example, if the SL PRS configuration results in a SL PRS comb using only 1/N of the REs in a sub-channel, the resulting measurement may be scaled up by a factor of N.

In at least one embodiment, these two metrics can be redefined based on the granularity of the resource reservation for SL-PRS.

In at least one embodiments RSSI (received signal strength indicator) measurements are used for determining CBR. In at least one embodiments, RSRP (reference signal received power) measurements are used for determining CBR. The difference is that RSSI may only measures whether a radio resource (e.g., sub-channel, RE) carries signal power whereas RSRP measures whether a specific reference signal (RS) is conveyed using a set of radio resources. That is, RSRP is a coherent measurement.

### Congestion Control Actions

In at least one embodiment, the UE 22 that has exceeded the CR limit, for transmission of SL PRS, can switch to
another positioning dedicated pool; or
the shared pool

In at least one embodiment, the UE 22 can adjust the SL PRS configurations to adjust its transmission load. For example, the UE 22 may adjust:
The utilization in time of radio resources for transmission of SL PRS (e.g., a periodicity of transmission; a transmission rate; how often it performs transmissions of SL PRS, etc.); or
The utilization in frequency of radio resources for transmissions of SL PRS (e.g., a number of REs used per transmission of SL PRS; a comb size; a BW allocation, etc.)

In at least one embodiment, the UE 22 determines to drop a transmission of SL PRS in response to the measurement. For example, for certain values or value ranges of CR and/or CBR, the UE 22 may (temporarily) decide to drop transmission of (some) SL PRS. By reducing the number of transmissions of SL PRS, the UE may reduce its CR down to a level that allows to resume transmission of SL PRS (potentially at a reduced rate).

In at least one embodiment, if the UE 22 is getting close to the CR limit, the UE 22 can decide to participate in the positioning procedure only if it can offer the required QoS.

In at least one embodiment, the available number of SL PRS sequences depends on the congestion control measurements. For example,
If the measured load (e.g., using CBR) is in a first range, then N1 SL PRS sequences (or cyclic shifts; or comb configurations, etc.) may be used.
If the measured load (e.g., using CBR) is in a second range, then N2 SL PRS sequences (or cyclic shifts; or comb configurations, etc.) may be used.

The measurements for SL PRS could be captured in a specification such as, e.g., 3GPP TS 38.215, according to the following non-limiting examples:

### 5.1.X Sidelink Channel Busy Ratio for SL PRS (SL CBR-PRS)

| | |
|---|---|
| Definition | SL Channel Busy Ratio for SL PRS (SL CBR-PRS) |
| | measured in slot n is defined as the portion of resources in |
| | the resource pool for which a SL RSRP on SL PRS measured |
| | by the UE exceed a (pre-)configured threshold sensed over a |
| | CBR measurement window [n-a, n-1], wherein a is equal to |
| | 100 or 100 · 2μ slots, according to higher layer parameter sl- |
| | TimeWindowSizeCBR. |
| Applicable | RRC_IDLE intra-frequency, |
| for | RRC_IDLE inter-frequency, |
| | RRC_CONNECTED intra-frequency, |
| | RRC_CONNECTED inter-frequency |

### 5.1.X Sidelink Channel Busy Ratio for SL PRS (SL CBR-PRS)

| | |
|---|---|
| Definition | SL Channel Busy Ratio for SL PRS (SL CBR-PRS) |
| | measured in slot n is defined as the portion of SL PRS |
| | sequences configured in the resource pool for which a SL |
| | RSRP on the SL PRS measured by the UE exceed a (pre-) |
| | configured threshold sensed over a CBR measurement |
| | window [n-a, n-1], wherein a is equal to 100 or 100 · 2μ slots, |
| | according to higher layer parameter sl- |
| | TimeWindowSizeCBR. |
| Applicable | RRC_IDLE intra-frequency, |
| for | RRC_IDLE inter-frequency, |
| | RRC_CONNECTED intra-frequency, |
| | RRC_CONNECTED inter-frequency |

### Example Embodiments

Example A1. A UE 22 configured to communicate with another device, the UE 22 configured to, and/or comprising a radio interface and/or processing circuitry 84 configured to:
perform a measurement, the measurement corresponding to a load associated with transmission of a sidelink positioning reference signaling, SL PRS; and
transmit the SL PRS to the other device based on at least one of a parameter or behavior, at least one of the parameter or behavior being adapted based on the measurement.

Example A2. The UE 22 of Example A1, wherein the transmission of the SL PRS is based on a lookup table of a plurality of channel busy radio, CBR, ranges and channel occupancy ratio, CR, limits.

Example A3. The UE 22 of Example A1, wherein the parameter includes a channel busy radio, CBR, parameter, and the CBR parameter is determined based on at least one of a received signal strength indicator (RSSI) and a reference signal received power, RSRP.

Example A4. The UE 22 of Example A1, wherein adapting the behavior includes at least one of:
selecting a positioning dedicated pool;
selecting a shared pool;
adjusting a transmission load;
dropping an SL PRS transmission; and
participating in a positioning procedure based on whether the UE can offer a required quality of service, QoS.

Example A5. The UE 22 of Example A1, wherein the other device is another UE.

Example B1. A method implemented in a UE 22, the method comprising:
performing a measurement, the measurement corresponding to a load associated with transmission of a sidelink positioning reference signaling, SL PRS; and
transmitting the SL PRS to another device using at least one of a parameter or behavior, at least one of the parameter or behavior being adapted based on the measurement.

Example B2. The method of Example B1, wherein the transmission of the SL PRS is based on a lookup table of a plurality of channel busy radio, CBR, ranges and channel occupancy ratio, CR, limits.

Example B3. The method of Example B1, wherein the parameter includes a channel busy radio, CBR, parameter, and the CBR parameter is determined based on at least one of a received signal strength indicator (RSSI) and a reference signal received power, RSRP.

Example B4. The method of Example B1, wherein adapting the behavior includes at least one of:
selecting a positioning dedicated pool;
selecting a shared pool;
adjusting a transmission load;
dropping an SL PRS transmission; and
participating in a positioning procedure based on whether the UE can offer a required quality of service, QoS.

Example B5. The method of Example B1, wherein the other device is another UE.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| PRS | Positioning Reference Signal |
| RSRP | Reference Signal Received Power |
| SL | Side link |
| V2X | Vehicular-to-everything |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-28. (canceled)

29. A user equipment, UE, configured to communicate with another device, the UE comprising processing circuitry configured to:
perform at least one measurement regarding sidelink positioning reference signaling, SL-PRS, based on a total number of resources in a resource pool dedicatedly configured for SL-PRS and a total number of resources occupied by the UE over a time interval; and
perform at least one congestion control action for SL-PRS based on the at least one measurement.

30. The UE of claim 29, wherein the number of resources occupied by the UE is a number of occupied resource elements that are occupied by the UE during the interval.

31. The UE of claim 30, wherein the at least one measurement comprises at least one of a channel busy ration, CBR, for SL-PRS and channel occupancy ration, CR, for SL-PRS.

32. The UE of claim 31, wherein when the at least one measurement comprises a CBR measurement for SL-PRS, the CBM measurement being an Received Signal Strength Indicator, RSSI, of the number of resources used by the UE for SL-PRS and the number of resources configured for the dedicated SL-PRS resource pool during the interval.

33. The UE of claim 30, wherein the at least one congestion control action comprises:
switching to another SL-PRS dedicated resource pool; or
adjusting a utilization in time and/or frequency of radio resources for transmission of SL PRS.

34. The UE of claim 33, wherein the adjusting the utilization in time of radio resources comprises adjusting at least one of a periodicity of transmission, a transmission rate, and how often SL PRS transmissions are performed; and the adjusting the utilization in frequency of radio resources comprises adjusting at least one of a number of resource elements used per SL PRS transmission, a comb size, and a bandwidth allocation.

35. The UE of claim 29, wherein the number of resources occupied by the UE is a number of SL-PRS combs that are used by the UE during the interval.

36. The UE of claim 35, wherein the at least one measurement comprises at least one of a channel busy ration, CBR, for SL-PRS and channel occupancy ration, CR, for SL-PRS.

37. The UE of claim 36, wherein when the at least one measurement comprises a CBR measurement for SL-PRS, the CBM measurement being an Received Signal Strength Indicator, RSSI, of the number of resources used by the UE for SL-PRS and the number of resources configured for the dedicated SL-PRS resource pool during the interval.

38. The UE of claim 29, wherein the at least one congestion control action comprises:
switching to another SL-PRS dedicated resource pool; or
adjusting a utilization in time and/or frequency of radio resources for transmission of SL PRS.

39. The UE of claim 38, wherein the adjusting the utilization in time of radio resources comprises adjusting at least one of a periodicity of transmission, a transmission rate, and how often SL PRS transmissions are performed; and
the adjusting the utilization in frequency of radio resources comprises adjusting at least one of a number of resource elements used per SL PRS transmission, a comb size, and a bandwidth allocation.

40. A method performed by a user equipment, UE, configured to communicate with another device, the method comprising:
performing at least one measurement on sidelink positioning reference signaling, SL-PRS, based on a total number of resources in a resource pool dedicatedly configured for SL-PRS and a total number of resources occupied by the UE over a time interval; and
performing at least one congestion control action for SL-PRS based on the at least one measurement.

41. The method of claim 40, wherein the at least one measurement is based on a total number of resource elements occupied by the UE over the time interval divided by a total number of radio resource elements of the resource pool dedicatedly configured for SL-PRS transmission over the time interval.

42. The method of claim 41, wherein the at least one measurement comprises a channel busy ratio, CBR, measurement on SL-PRS in a slot n; wherein the total number of resources occupied by the UE comprises a number of radio resource used by the UE over a measurement window prior to the slot n.

43. The method of claim 42, wherein the radio resource used by the UE in the CBR measurement on SL-PRS is radio resource of which a measured Received Signal Strength Indicator, RSSI, exceeding a configured threshold.

44. The method of claim 40, wherein the at least one measurement comprises a channel busy ratio, CBR, measurement on SL-PRS in a slot n; wherein the total number of resources occupied by the UE comprises a number of radio resource used by the UE over a measurement window prior to the slot n.

45. The method of claim 44, wherein the radio resource used by the UE in the CBR measurement on SL-PRS is radio resource of which a measured Received Signal Strength Indicator, RSSI, exceeding a configured threshold.

46. The method of claim 40, wherein the at least one measurement comprises a channel occupancy ratio, CR, measurement on SL-PRS in slot n; and
wherein the total number of resources occupied by the UE comprises a number of radio resource used by the UE over a first period prior to the slot n and a number of radio resource granted for the UE over a second period on and after the slot n, where sum of the first and second period equals the time interval.

47. The method of claim 40, wherein performing at least one congestion control action for SL-PRS comprising:
switching to another SL-PRS dedicated resource pool; or
adjusting a utilization in time and/or frequency of radio resources for transmission of SL PRS.

48. The method of claim 47, wherein the adjusting the utilization in time of radio resources comprises adjusting at least one of: periodicity of transmission, transmission rate, and how often SL PRS transmissions are performed; and the adjusting the utilization in frequency of radio resources comprises adjusting at least one of: a number of resource elements used per SL PRS transmission, comb size, and bandwidth allocation.
